(19) United States
(12) Patent Application Publication
(10) Pub. No.: US 2002/0087876 A1
(43) Pub. Date: Jul. 4, 2002

(54) Adaptive software installation process supporting multiple layers of security-related attributes

(76) Inventor: Gordon Edward Larose, Ottawa (CA)

Correspondence Address: SMART & BIGGAR, P.O. BOX 2999, STATION D, 55 METCALFE STREET, SUITE 900, OTTAWA, ON, K1P5Y6, CA

(21) Appl. No.: 09/749,421

(22) Filed: Dec. 28, 2000

(51) Int. Cl. G06F 9/44

(52) U.S. Cl. 713/200

(57) ABSTRACT

A system for providing security for programs installed in a computer is disclosed in which the original program is divided into versions of increasing functionality and in which higher functioning versions depend upon and utilize security-related attributes of the computer on which the program is to be executed. The versions are installed on the user's computer. Upon initiation of execution of the lowest functioning version, the security-related attributes of the user's computer are inspected and the execution of the second version is initiated in the place of the first version if the security-related attributes of the second computer support the increased functionality of the second version. If so, the security-related attributes are used in the second version prior to execution. In either case, the remaining version is then executed without the need for further intervention for security purposes.

### FIELD OF THE INVENTION

This invention relates to computer systems and in particular to improved systems, methods and apparatus for providing security for programs installed in computer systems.

### BACKGROUND OF THE INVENTION

Since the start of the personal computing era in the late 1970s, software publishers have been concerned with software piracy, that is, the unlicensed copying, or installation, or use of software by the user.

Most unprotected software programs can be easily copied onto transportable media. Accordingly, such software may be and is often installed on one or more personal computers other than the one for which the software was originally licensed, without the publisher being able to recover any additional licence fees from the users of these additional computers. The advent of network connections means that even the minimal requirement of transportable media is obviated. It is understood for the purposes of this invention that the term “computer” includes any generally programmable processor-based device, including but not limited to, personal computers, video game consoles, Personal Digital Assistants and wireless devices.

Copy protection approaches known in the art have represented a trade-off because the effectiveness of the protection generally has a direct correlation to the intrusiveness of the protection approach. More generally, the field of Digital Rights Management seek to control use of all forms of digital goods and limit such use only to authorized users. The same tradeoffs also apply in this field.

In the current art there are various software-only approaches that are minimally intrusive, but many of them are also only minimally effective. Such approaches often involve code that attempts to obtain an authentication, in the form of a registration number or a password.

In the most simple and most easily implemented approaches to Digital Rights Management, authentication is verified at the time of installation to permit access to the software. Once the authentication has been verified, the software is forever unlocked and can be used with impunity and even copied to other computers, whether that of the user or that of another.

For example, U.S. Pat. No. 6,041,411, entitled “Method for defining and verifying user access rights to a computer information” issued Mar. 21, 2000 to Wyatt, discloses a system for the secure purchase of software. The software cannot be executed unless the user enters an activation code into the computer prior to the first execution of the software.

U.S. Pat. No. 6,009,525 entitled “Multi-tier electronic software distribution” issued Dec. 28, 1999 to Horstmann, is a slightly more complex variant. It discloses an incremental shrink-wrapping process in which each stage of the software distribution process can edit distribution rules which must be satisfied, before that shrink-wrapping layer will be unlocked. When all of the shrink-wrapping layers have been unlocked, the software may be installed and subsequently used with impunity.

Another example of such an approach is U.S. Pat. No. 5,337,357 entitled “Method of software distribution protection” issued Aug. 9, 1994 to Chou et al. Random and unique identifiers are obtained from the hardware environment of the computer on which the software is to be installed and executed. The installation utility generates a first key that the user communicates to the vendor, who calculates a unique second key based on the first key and a decrypting key. The second key entered by the user into the computer is compared against both the first key data and the underlying identifiers on the computer to validate both the key and the computer prior to installation.

More sophisticated software approaches are used to provide increased effectiveness. They cause the software to automatically retrieve information such as a user authentication from the architecture of the computer itself or externally, in the form of a password which was entered into the computer memory at an earlier point for subsequent reference by the program. The intrusion of the approach is minimized because the software automatically retrieves the authentication, so that the performance of the software is not materially impaired by the protection scheme.

However, the open, multitasking nature of personal computers renders such software approaches relatively vulnerable to attack. Because multiple processes can operate concurrently, with each process having access to the entirety of the computer, the software putatively protected by such software approaches may co-exist with other software, such as a software debugger, which can be used to examine the actions and responses of the protected software. Accordingly, the control mechanisms can be identified and the code of the protected software modified to disable the protection only.

Such attacks can be made extremely difficult by appropriate design of the software protection mechanisms. For example, in U.S. Pat. No. 5,935,246 entitled “Electronic copy protection mechanism using challenge and response to prevent unauthorized execution of software” issued Aug. 10, 1999 to Benson, there is disclosed an electronic copy protection scheme using public key cryptography. The software periodically issues an encrypted challenge which encompasses both the public key adopted by the user and the private key adopted by the vendor, which information is contained in a keyfile generated by the vendor upon registration of the software from information provided by the user. The keyfile may contain hidden information concerning selective activation of services of the copy-protected program.

However, such approaches cannot in principle be made inviolable. The modified software that results from a successful attack can then be circulated with impunity and used even by technically unsophisticated users of the software.

Rather the approaches depend on making it so difficult to defeat the Digital Rights Management scheme that the potential gain from doing so is outweighed by the effort in achieving it. However in achieving this result, the software developer must typically expend considerable effort and expense to implement such a scheme.

An example is U.S. Pat. No. 5,940,590, entitled “System and method for securing computer-executable program code using task gates” and issued Aug. 17, 1999 to Lynne et al. A system of securing program code modifies the original software prior to installation to introduce so-called task gates. These gates will control unauthorized entry to a task or boost the user's authority while the task is executed. The task gates determine, when they are encountered during execution, whether the user executing the modified software meets the security authorizations specified by the gate. Accordingly, this process consumes significant development resources, as the software developer must identify each task to be protected, the exact security authorization to be specified and insert the appropriate task gates.

A recently popular variant of such software approaches is to provide multi-level security. For example, a software program may be sold to a user with minimal functionality at the outset, but with considerable additional functionality installed but not immediately accessible. The software purchaser may use the minimal functionality software with impunity, and even copy it, but will not be permitted to access the additional functionality until an additional licence fee is paid. Upon payment of the fee, the purchaser is provided with a password or key that can be supplied to the software, for example by typing it into a registration window, thereafter unlocking some or all of the enhanced features. This multi-level security feature provides marketing advantages in terms of ability to try out software and convenience.

However, the multi-level security feature is at its essence a software security device and subject to the class of attacks previously described.

There have been a number of approaches in which the run-time execution of a process is interrupted to obtain security information. Such approaches can be made effective by increasing the extent of run-time intervention required by the protection scheme.

For instance, the user can be prompted to provide the authentication at certain points in the execution of the software. Other approaches require ongoing interaction with and/or support by the software vendor.

For example, in U.S. Pat. No. 6,009,543 entitled “Secure software system and related techniques” issued Dec. 28, 1999 to Shavit, there is disclosed a processing system which includes a code extraction processor. The code extraction processor parses an original software program into a first and second program, where the first program is made freely available to the user. The second program contains a small portion of the program that is required for proper execution of the program and is installed on a dedicated server operated by the software vendor. The second program is made selectively available to the user by means of queries along a communications network from the first program on the user's computer to the dedicated server on which the second program resides.

However, with such increased intervention, the performance of the software will be correspondingly degraded. Such approaches therefore are generally characterized by delay or slow execution, as the security investigation takes place on a number of occasions during and throughout the execution of the software. Eventually, the user perceives the intervention as a nuisance.

Other effective protection approaches involve the use of hardware. Generally, the computer on which the software is to execute is required to have installed a secure, tamper-resistant hardware-based adjunct device. An example of this is the “dongle”, a piece of hardware that attaches to a personal computer via one of its external ports, and which is required in order for the software to properly function. Other examples include smart cards and cryptographic co-processor chips located on personal computer internal buses or peripheral cards.

Such hardware security devices are effectively “on-off” solutions, that is, they can be used only to allow or deny the use of the software in its entirety. Multiple levels of functionality cannot be accommodated by a single such device. Rather a plurality of such devices would be required.

These approaches are also effective, but suffer from intrusiveness of a different character. Rather than impacting the run-time performance by requiring user input, hardware approaches are inconvenient because of the requirement for a hardware adjunct device. The hardware components generally add to the purchase price of the software and consumers are generally unwilling to bear this additional cost, especially when its sole purpose is to prevent them from doing with the software what they otherwise could freely do. Moreover, the hardware component is a tangible and often visual reminder of the lack of trust that the software manufacturer has for the consumer of its products, with attendant marketing drawbacks. For this reason, such hardware approaches have to date obtained limited commercial acceptance.

The lack of commercial acceptance of hardware adjunct devices has led to a “Catch-22” situation. The manufacturers of personal computers will not add the capability to accommodate such hardware components if consumers are unwilling to pay for it, especially since there is no direct benefit to the manufacturer for so doing. Sales of such devices will be adversely impacted if there are only a small number of computers that can accommodate them. Moreover, software publishers will not write software that makes use of such capability unless and until there is a significant base of personal computers having such capability.

Nevertheless, it is anticipated that the installed base of computers that will accommodate and have installed such devices will gradually increase. Eventually, the installed base will reach a critical mass and hardware protection schemes will become a viable alternative.

### SUMMARY OF THE INVENTION

Accordingly, it would be advantageous to provide simple, inexpensive and efficient mechanisms for implementing such protection schemes into software products under development.

Additionally, it would be advantageous to provide mechanisms to retrofit such protection schemes into software products that are already on the market and have not yet become outdated without significant development effort.

Accordingly, it is desirable to provide an improved system for securing computer programs that is convenient, effective and does not require material interruption of the program execution.

The present invention accomplishes these aims by providing a system in which the original software is transformed into a plurality of versions, each having a different level of capability. A first version with less capability than a second version contains inspection functions that identify security-related attributes of the computer on which the software is to be executed. The second version contains binding functions that make use of the security-related attributes of the computer associated with that version of the software.

All of the versions are available for installation on the user's computer. As part of the startup of the first version, its inspection functions are invoked and if the security-related attributes required for the second version are found in the user's computer the second version is started up in the place of the first version. When the second version executes, the binding functions are invoked and the security-related attributes of the user's computer are invoked by the executable image.

According to a broad aspect of an embodiment of the present invention, there is disclosed a processing system comprising: a generation processor at a first computer to receive an original software product and to provide a first version of the software having a limited functionality and a second version of the software having increased functionality which is dependent upon and utilizes security-related attributes of the computer on which the software is to be executed; and an execution processor at the second computer, adapted to receive the versions of the software from the first computer, comprising: an assessor for identifying, prior to execution of the first version, the security-related attributes of the second computer; a version initiator for initiating the execution of the second version in the place of the first version if the security-related attributes of the second computer supports the increased functionality of the second version during which the security-related attributes of the second computer are utilized; and a code processor for executing the version of the software to be executed.

According to a second broad aspect of an embodiment of the present invention, there is disclosed a generation processor at a first computer to receive an original software product and to provide a first version of the software having a limited functionality and second version of the software having increased functionality which is dependent upon and utilizes security-related attributes of the computer on which the program is to be executed, whereby an execution processor at the second computer may receive the versions of the software from the first computer, identify, prior to execution of the first version, the security-related attributes of the second computer, initiate the execution of the second version in the place of the first version if the security-related attributes of the second computer supports the increased functionality of the second version during which the security-related attributes of the second computer are utilized, and execute the version of the software to be executed.

According to a third broad aspect of an embodiment of the present invention, there is disclosed an execution processor at a second computer for receiving from a first computer, a software product for execution on the second computer in the form of a first version of the software having a limited functionality and a second version of the software having increased functionality which is dependent upon and utilizes security-related attributes of the computer on which the program is to be executed, the execution processor comprising: an assessor for identifying, prior to execution of the first version, the security-related attributes of the second computer; a version initiator for initiating the execution of the second version in the place of the first version if the security-related attributes of the second computer supports the increased functionality of the second version during which the security-related attributes of the second computer are utilized; and a code processor for executing the version of the software to be executed.

According to a fourth broad aspect of an embodiment of the present invention, there is disclosed a method of selectively controlling the functionality of a software product, the method comprising the steps of: generating, at a first computer, a first version of the software having a limited functionality and a second version of the software having increased functionality which is dependent upon and utilizes security-related attributes of the computer on which the program is to be executed; receiving the versions of the software from the first computer, at a second computer for execution thereon; identifying, prior to execution of the first version, the security-related attributes of the second computer; initiating the execution of the second version in the place of the first version if the security-related attributes of the second computer supports the increased functionality of the second version during which the security-related attributes of the second computer are utilized; and executing the version of the software to be executed.

According to a fifth broad aspect of an embodiment of the present invention, there is disclosed a computer-readable medium for storing computer-executable instructions which, when executed by a processor in a first computer, cause the processor to: receive an original software product and to provide a first version of the software having a limited functionality and a second version of the software having increased functionality which is dependent upon and utilizes security-related attributes of the computer on which the program is to be executed, whereby an execution processor at the second computer may receive the versions of the software from the first computer, identify, prior to execution of the first version, the security-related attributes of the second computer, initiate the execution of the second version in the place of the first version if the security-related attributes of the second computer supports the increased functionality of the second version during which the security-related attributes of the second computer are utilized and execute the version of the software to be executed.

According to a sixth broad aspect of an embodiment of the present invention, there is disclosed a computer-readable medium for storing computer-executable instructions which, when executed by a processor in a second computer, cause the processor to; receive from a first computer, a software product for execution on the second computer in the form of a first version of the software having a limited functionality and a second version of the program having increased functionality which is dependent upon and utilizes security-related attributes of the computer on which the program is to be executed, identify, prior to execution of the first version, the security-related attributes of the second computer; initiate the execution of the second version in the place of the first version if the security-related attributes of the second computer supports the increased functionality of the second version during which the security-related attributes of the second computer are utilized; and execute the version of the software to be executed.

### BRIEF DESCRIPTION OF THE DRAWINGS

The embodiments of the present invention will now be described by reference to the following figures, in which identical reference numerals in different figures indicate identical elements and in which:

FIG. 1 is a diagrammatic representation of the interplay between versions of the software generated by the embodiment of FIG. 1;

FIG. 2 is a block diagram of a hardware environment in which the embodiment of FIG. 1 will operate;

FIG. 3 is a diagrammatic representation of an embodiment of the present invention;

FIG. 4 is an example of a metadata file used in the embodiment of FIG. 1; and

FIG. 5 is a flow chart showing the execution processing of the embodiment of FIG. 1.

### DETAILED DESCRIPTION OF THE PREFERRED EMBODIMENTS

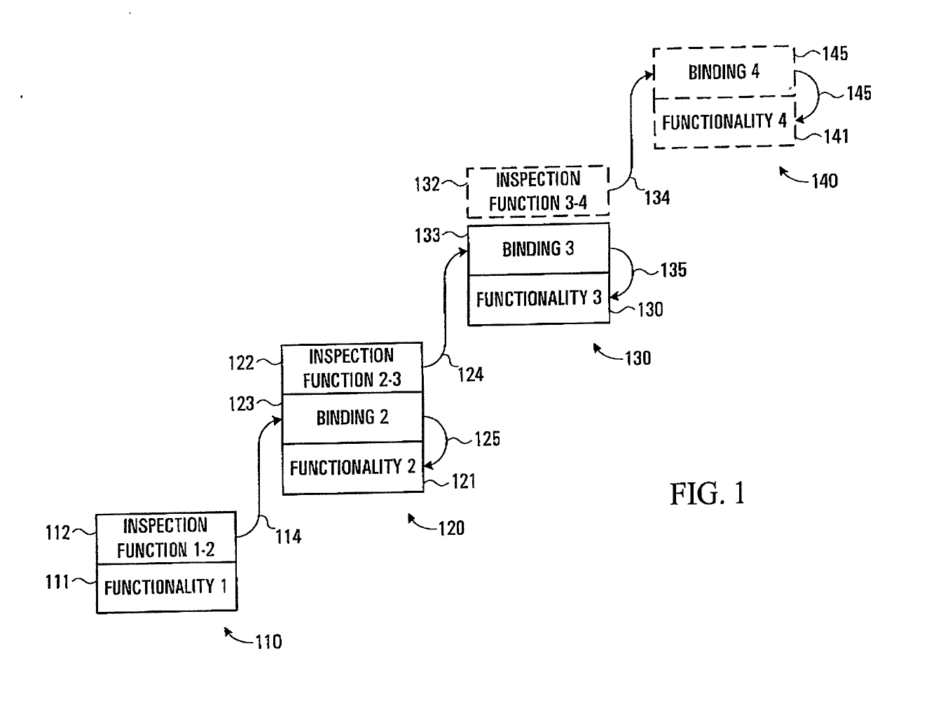

Referring now to FIG. 1, there is shown a diagrammatic representation of the interplay between versions of a software product generated by an embodiment of the present invention.

In software suitable for application of the present invention, functionality can be allocated among a plurality of versions of software 110, 120, 130, 140 of respectively increasing capability. Higher capability versions will make use of some security-related attribute of the computer in which the versions are installed for execution.

Such security-related attributes are primarily embodied in hardware, although it is possible that some may be embodied in software. Typical hardware security-related attributes may include adjunct devices, whether or not tamper resistant, including cryptographic co-processors that contain cryptographic keys in protected storage, dongles attached to external ports that contain cryptographic capabilities, or smart-cards and smart-card readers.

However, security-related attributes need not be security-specific. Indeed the attribute may be nothing more than the presence or absence of a hard drive, an internet connection, an authenticable security capability on a network coupled to the computer, a user certificate such as an X.509 certificate or an independent authentication for user identification.

Software attributes, such as the presence of a runtime debugger (suggesting an attempt at bypassing security efforts) or evidence of the purchase of an upgrade of the software may be considered.

Indeed, the presence or absence of virtually any hardware or software attribute of the environment in which the computer may execute programs may qualify as a security-related attribute for the purposes of the present invention.

The sole requirement is that the software product must be capable of determining if the attribute is present on the computer on which the software product is to execute and if so, using the attribute during execution.

A plurality of security-related attributes may be considered together to compute a figure of merit.

For simplicity, and by way of example, we will consider a single-player game program that executes on a personal computer using a Microsoft Windows™ operating system. The game program, which has already been developed, is available in three versions.

The first version 110 is to be made available freely, and operates as a “demo” version of the game. As such, while it is unrestricted in distribution and use, it is severely limited in functionality, for example, only one game level is accessible and the game engine is of a basic variety.

The second version 120 makes available additional game levels but makes use of the same game engine as in the first version 110. The publisher wishes to make the second version 120 available free of charge to users who possess a certain class of smart-card reader and a suitably encoded smart-card which will authenticably identify the user. Thus, the second version 120 is made available to users in return for obtaining personal information about the user, which can be used for targeted marketing purposes.

The third version 130 makes available still more game levels than the second version 120, and incorporates an enhanced game engine to replace the basic game engine of the first version 110 and second version 120. The third version 130 will be only made available to users with access to the second version 120 who are willing to purchase the increased capability of the third version 130 via an internet e-cash transaction.

Thus, in the exemplary embodiment of FIG. 1, only versions 110, 120 and 130 will be created. Accordingly, version 140, which is discussed later, is shown in dotted outline together with other related elements.

Persons having ordinary skill in this art will readily recognize that the present invention can be incorporated into any number of types and versions of software application. The minimum requirement is that the software application must have at least two versions of varying functionality 111, 121, 131, 141 or be capable of being so divided. Further, the version or versions having increased functionality 121, 131, 141 make use of one or more of the security-related attributes of the computer on which the software product is to execute.

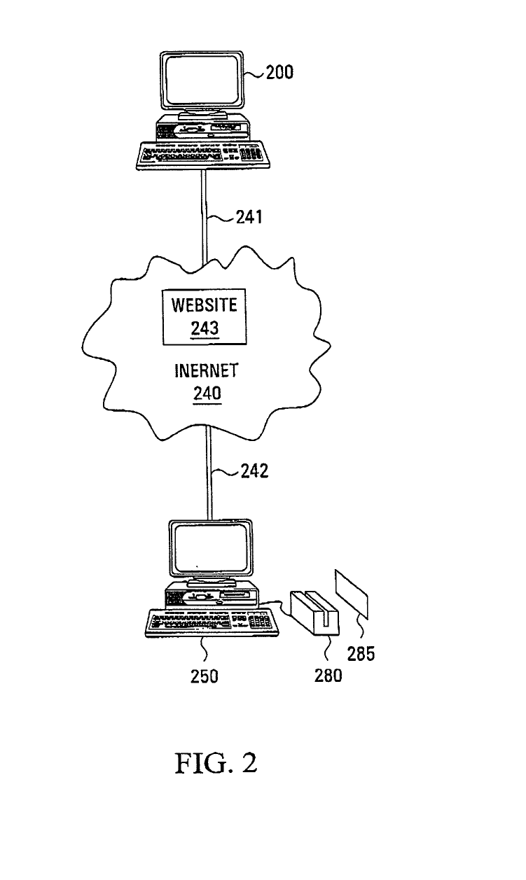

Referring now to FIG. 2, there is shown a block diagram of a hardware environment in which the embodiment of FIG. 1 will operate. The hardware environment comprises a development PC 200 and an execution PC 250, interconnected by internet network 240.

The development PC 200 is the environment on which the versions 110, 120, 130, 140 of the software product will be generated. The versions 110, 120, 130, 140 may be generated after the completion of the development of the original software, as in the exemplary embodiment described above. In such a case, the development PC 200 need only have sufficient capability to execute the conversion processing software described below.

Alternatively, the versions 110, 120, 130, 140 may be generated in the course of development of the original software. In this case, the development PC 200 must have sufficient capability to support the software development process in its entirety, in addition to the capability required to execute the conversion software processing.

The execution PC 250 is the environment in which the versions 110, 120, 130, 140 will execute. Accordingly, the execution PC 250 must have sufficient capability to support the processing of the software product, including, if appropriate, some or all of the security-related attributes associated with the higher capability versions 120, 130, 140 of the software.

In FIG. 2, the security-related attributes include a smart-card reader 280. The smart-card reader 280 accepts a smart-card 285 containing processing capabilities. When inserted into the smart-card reader 280, the smart-card 285 makes available an authenticated user identification to the execution PC 250 which can be used by software processes executing on it.

The internet 240 is a network of network processors (not shown) which are inter-linked and provide a number of communications pathways through the network for appropriation on a shared basis by processors connected by a communications link to one of the network processors.

The development PC 200 is connected to the internet 240 by a broadband internet connection 241 and the execution processor 250 is similarly connected to the internet 240 by a broadband internet connection 242.

A plurality of web sites including web site 243 are conceptually shown within internet 240. In fact, they are installed on processors (not shown) for access by users of the internet 240. Web-site 243 is operated by the software developer and is updated from development PC 200.

The software developer uses web-site 243 to download the versions 110, 120, 130, 140 of the software product to users such as the one associated with execution PC 250. Those of ordinary skill in this art will readily recognize that there are other mechanisms for transfer of the versions 110, 120, 130, 140 of the software product to users, including distribution of a transportable media such as CD-ROM or a diskette or along a local area network (not shown).

In the exemplary embodiment discussed above, web-site 243 also provides a mechanism to permit the e-cash transaction required to permit access to the third version 130 of the software product.

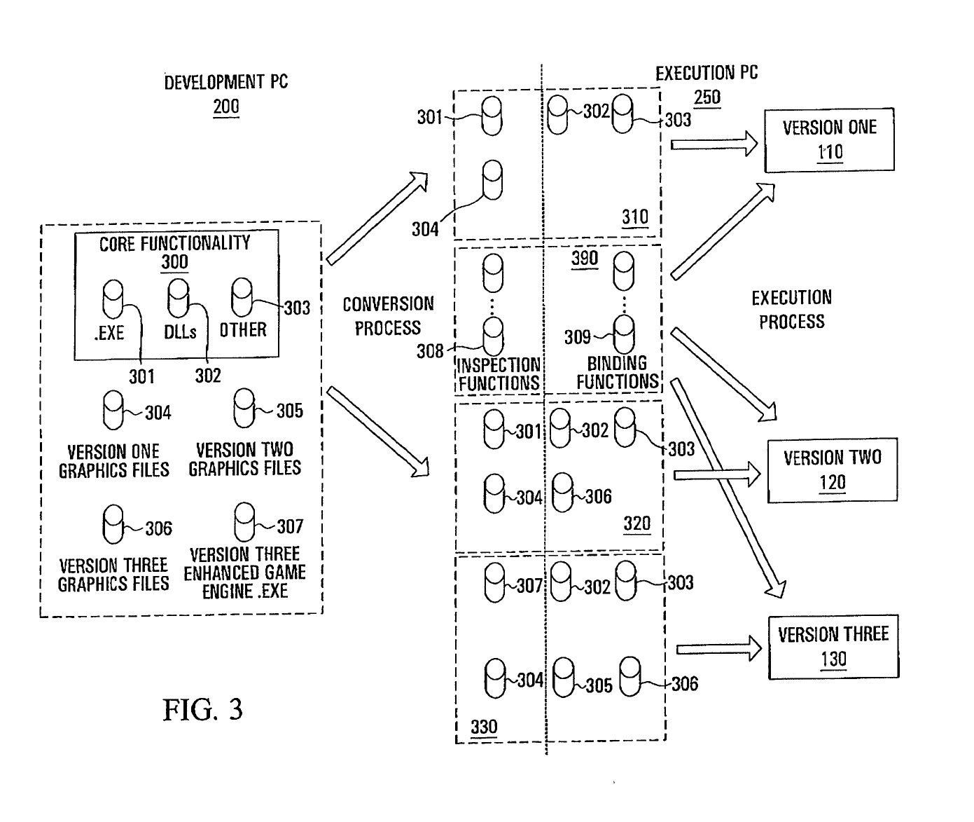

Turning now to FIG. 3, there is shown a diagrammatic representation of the processing involved in the present invention. The elements concerned with producing the multilevel application are shown to the left of the dotted vertical line occur at the development PC 200, while the multilevel applications themselves and the processes involved in their use are shown to the right, at the execution PC 250. Boxes 310, 320 and 330 represent respectively, the executable images for the first, second and third versions respectively. They are shown overlaying the dotted vertical line to denote that they are created at the development PC 200 and are transported for installation onto the execution PC 250 as discussed above.

In the exemplary embodiment, the software versions have already been developed and are shown as a core functionality 300 and additional files 304-307. The core functionality 300 generally comprises an executable image (.EXE) 301, a series of dynamic link libraries (DLLs) 302 to perform certain basic functions and other miscellaneous files 303. In addition, there are graphics files for each of the versions, 304-306 and an executable image comprising the enhanced game engine 307 to be used for the third version.

The implementation of the exemplary embodiment comprises the application of a conversion process at the development PC 200 on the existing software application 300-307 to create a corresponding set of executable files 310, 320, 330 for installation on the execution PC 250. The (in this case three) sets of executable files 310, 320, 330 may have considerable overlap between them but are conceptually different and all are installed on the execution PC 250.

The conversion process performed at the development PC 200 involves injecting two types of functions into the executable files corresponding to the software versions to be converted, inspection functions denoted generally as 308 and binding functions denoted generally as 309.

In the exemplary embodiment discussed above, the inspection functions 308 and the binding functions 309 are implemented in a DLL library 390 that mediates the behavior of the executable images.

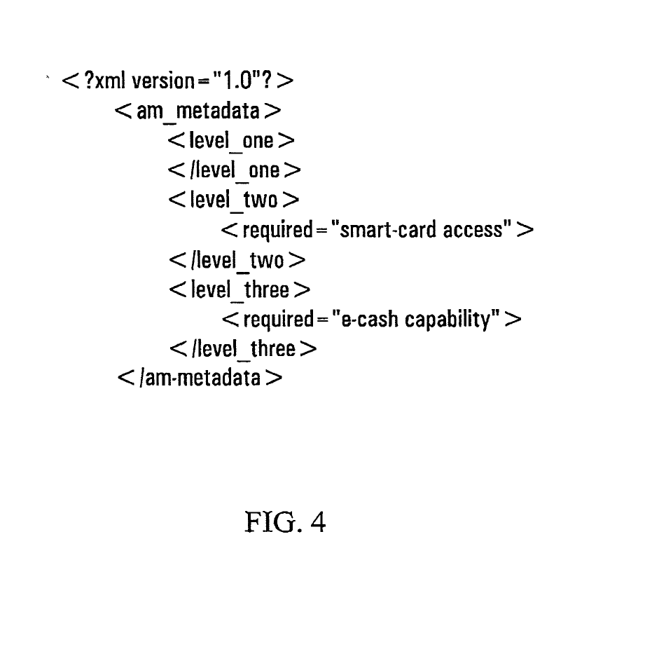

The specific dependencies that will be enforced in a particular set of executable files are established by files of metadata which specify which inspection and/or binding functions should be executed. An exemplary metadata file showing the specification of inspection files is shown in FIG. 4.

The executable image corresponding to the three versions of the software 110, 120, 130, will result from linking the DLL library 390 to the corresponding executable files 310, 320, 330 at the start of execution. Those having ordinary skill in this art will readily recognize that this is not the only configuration to permit the injection of such functions and such a mechanism is for exemplary purposes only.

The advantage of using DLL files for the inspection 308 and binding functions 309 is the ease in which additional versions of software capability can be added. The developer must only define additional inspection 132 and binding functions 145 (shown in dotted outline in FIG. 1), create the required version-specific functionality 141 and modify the metadata files. The existing executable files 310, 320, 330 would be left undisturbed.

The executable files use the inspection functions 308 injected into them to detect the presence or absence of one or more security-related attributes on the execution processor 250.

Thus, in the present example, the executable files corresponding to the first 310 and second versions 320 of the software will invoke inspection functions 112 to detect the presence or absence of a smart-card reader 280 of a certain type. In addition, the executable file for the second version of the software 320, will invoke inspection functions 122 to detect the presence or absence of an internet e-cash capability. On the other hand, the executable file corresponding to the third version of the software 330 will not invoke any inspection functions because there is no version of the software with any greater capability.

The executable files use the binding functions 309 injected into them to use the security-related attributes found on the execution processor 250 by the inspection functions 308 for the immediately lower version of the software. When the executable image 340, 350, 360 of the version to be run is starting up, it invokes the appropriate binding function 309. The binding function 309 ensures that the executable image can only be executed on a properly qualified computer environment. Because the finding function 309 is only invoked during startup, there is no material delay in the execution performance of the software version.

It will be readily recognized that the binding functions 309 may also be invoked during the execution of the executable image 340, 350, 360 as required by the software developer, but with the recognition that to do so risks a material degradation in the execution performance of the software version.

Thus, in the present example, the executable file for the second version of the software 320 will use binding functions 125 to intercept certain file read operations and to decrypt certain files using the smart-card 185 during the startup of the executable image corresponding to this version. This has the effect of restricting the present instance of the program to execution only on the specific computer, or, absent other bindings, only on a computer with the specific smart-card present.

Such intervention is well known in the art. In this example, it can be accomplished by means of a Virtual Device Driver (VxD) which hooks file read operations and deals with the smart-card interface to provide any required decryption.

Similarly, the executable file for the third version of the software 330 will use binding functions 135 to intercept file read operations and decrypt certain additional files using a decryption key provided upon completion of the e-cash transaction during the startup of the executable image corresponding to this version. The decryption key may have been stored upon receipt on the smart-card 185.

Those having ordinary skill in this art will readily recognize that the inspection functions 308 and/or binding functions 309 may result in modification of the system-level behavior of the software, whether by modification of the file input/output resources, user-machine interface, or operating system resources, including the use of proxies.

Once the conversion process has been completed and the executable files 310, 320, 330 and the DLL library 390 have been generated, these files are downloaded and installed on the execution processor 250. This may take place by conventional means with which users are already familiar, for example, by HTTP file transfer from the web-site 243 of a self-exploding installation file. It is also possible, in order to increase the security of the overall system, to defer the completion of the installation of higher levels dependent upon relevant security attributes. For example, the distribution files for the second level might be encrypted in such a way that they require decryption by security hardware before installation. In this manner, the higher levels are not available for malicious inspection such as disassembly, except to known users.

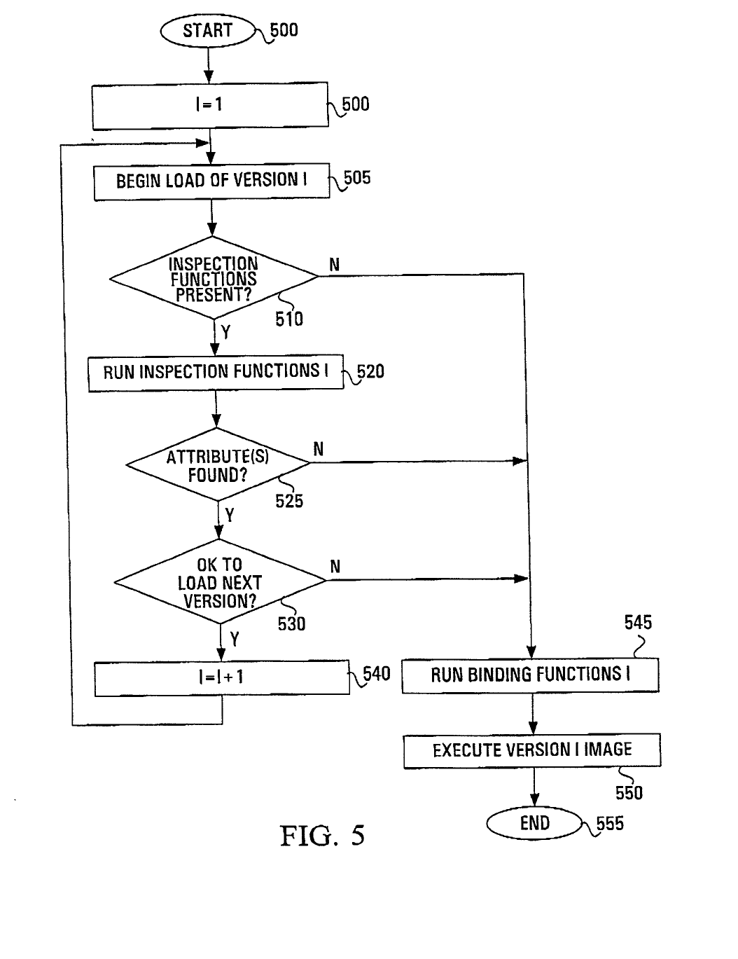

FIG. 5 is a flow chart showing the logical processing which occurs at the execution processor 250 to execute the software product. The start of the execution process 500 is signaled by a double click on an icon representing the executable file for the first version 310 in a manner well-known to users of computer graphical user interfaces.

The executable file for the first version 310 begins loading 505. Under the Windows™ operating system, the loader loads DLLs specified in the header of the executable file so invoked and also runs the “load-time” code, if any, present in each specified DLL, before loading the core program itself.

The DLL library 390 is specified in executable file 310 and accordingly is loaded by the loader. The load-time code of the DLL library 390 reads the appropriate metadata from a file to first determine whether there are inspection functions 308 to execute 510. The metadata also specifies which binding functions 309 to execute, but these are executed after any inspection functions.

The appropriate inspection functions (in this case, 112) are executed 520. The inspection functions are independent executable files which run under control of the DLL library 390. Inspection function 112 determines that smart-card 185 is loaded in smart-card reader 180.

The inspection function 112 may optionally query the user to secure permission to load the next (second) version 530. If so, the DLL library 390 spawns a separate process to load 505 the executable file for the second version 320 and the process corresponding to the execution of the first version will be allowed to die.

Similar processing will now take place during the load of the executable file for the second version 320 with the result that the inspection functions 122 will be executed which confirms that the execution processor 250 has e-cash capability.

The e-cash capability could be demonstrated, for instance by asking the smart-card 185 to decrypt a token message encrypted by a public key of a particular e-cash system, which would only succeed if the smart-card 185 contained a corresponding private key indicating membership in an e-cash program.

Note that decisions about making the next levels available such as were earlier described need not be performed in an entirely local manner, and may involve user interaction as long as the authorization resulting therefrom is authenticable. For example, the metadata for a particular level transition could specify a Universal Resource Locator (URL) of an internet-based transaction processor to which the user would be directed via a World Wide Web browser. The web-resident criteria for authorization could be arbitrary and return, for example, a success code in the form of a token which would be authenticated by a local smart-card.

Note that the executable files for the second 120 and third versions 130 have already been installed, whether or not the e-cash transaction has already taken place. The inspection function 122 therefore is configured to also check a robust success indicator, to determine if the e-cash transaction has already taken place. If not, the inspection function 122 offers the user the opportunity to purchase the enhanced software (either periodically or upon each invocation of the software). If the user agrees to do so and the transaction is completed, the robust success indicator is modified and the third version executable file 130 is loaded. The robust success indicator can thereafter easily be checked without any further input from the user.

When the executable file for the third version is loaded 330 and the DLL library 390 invoked, the metadata file indicates that there are no inspection functions to be executed, but that there are binding functions 133 to be executed. These binding functions 133 are executed, and upon completion, the executable file for the third version 330 is executed 550.

If the execution processor 250 did not have either e-cash capability or a smart-card capability, then the corresponding inspection functions 112, 122 would fail and any binding functions for the present version would execute 545, followed by the executable file for that version 550.

Apparatus of the invention can be implemented in a computer program product tangibly embodied in a machine-readable storage device for execution by a programmable processor; and methods actions can be performed by a programmable processor executing a program of instructions to perform functions of the invention by operating on input data and generating output. The invention can be implemented advantageously in one or more computer programs that are executable on a programmable system including at least one input device, and at least one output device. Each computer program can be implemented in a high-level procedural or object oriented programming language, or in assembly or machine language if desired; and in any case, the language can be a compiled or interpreted language. Suitable processors include, by way of example, both general and specific microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in ASICs (application-specific integrated circuits).

Examples of such types of computers are programmable processing systems contained in the development PC 200 and the execution PC 250 shown in FIG. 1 suitable for implementing or performing the apparatus or methods of the invention. The system may comprise a processor, a random access memory, a hard drive controller, and an input/output controller coupled by a processor bus.

It will be apparent to those skilled in this art that various modifications and variations may be made to the embodiments disclosed herein, consistent with the present invention, without departing from the spirit and scope of the present invention.

For example, the processing on the execution processor 250 has been described in the context of a Windows™ application. Those of ordinary skill in this art will readily recognize that similar processing can be accomplished in operating systems other than Windows™.

Further, as indicated above, once the executable file for a version commenced execution, the binding functions would have already been executed, and the executable file could run without interference, or at the option of the software developer, execute further binding functions during the course of execution.

Moreover, if the load-time processing of the second and higher versions is time consuming, the lower version process may be permitted to proceed to execution while the load of the higher version takes place, to be terminated upon commencement of execution of the higher version.

Those persons of ordinary skill in the art will also recognize that it is not essential that executable files corresponding to all of the versions of the software be loaded and installed at once.

Optionally, only the executable file for the first version 310 need be loaded and installed. In this case, the inspection function 112 could confirm that there is smart-card capability and monitor a robust success indicator to determine whether the executable file for the second version has been previously downloaded and installed. If not, the user may optionally be given the choice to effect the download, or the download may take place automatically.

The download may use, as a security measure, a URL from which the executable file may be downloaded. An encrypted version of the URL may be stored in the metadata file which is decrypted by the smart-card 185. For added security, the metadata corresponding to the second or higher versions may itself be encrypted. For still more security, the URL could be different for different users.

Similar processing could be applied to download the executable file for the third version 330 upon the first invocation of the executable file for the second version 320.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

We claim:

1. A processing system comprising:
a generation processor at a first computer to receive an original software product and to provide a first version of the software having a limited functionality and a second version of the software having increased functionality which is dependent upon and utilizes security-related attributes of the computer on which the software is to be executed; and
an execution processor at the second computer, adapted to receive the versions of the software from the first computer, comprising:
an assessor for identifying, prior to execution of the first version, the security-related attributes of the second computer;
a version initiator for initiating the execution of the second version in the place of the first version if the security-related attributes of the second computer supports the increased functionality of the second version during which the security-related attributes of the second computer are utilized; and
a code processor for executing the version of the software to be executed.

2. A generation processor at a first computer to receive an original software product and to provide a first version of the software having a limited functionality and second version of the software having increased functionality which is dependent upon and utilizes security-related attributes of the computer on which the program is to be executed,
whereby an execution processor at the second computer may receive the versions of the software from the first computer, identify, prior to execution of the first version, the security-related attributes of the second computer, initiate the execution of the second version in the place of the first version if the security-related attributes of the second computer supports the increased functionality of the second version during which the security-related attributes of the second computer are utilized, and execute the version of the software to be executed.

3. The generation processor according to claim 2 comprising:
a mapper for generating a map of the functions of the original software product into versions of the software.

4. The generation processor according to claim 2 comprising:
a generator for generating the versions of the software in accordance with a map of the functions of the original software product into versions of the software

5. The generation processor according to claim 4 wherein the generator inserts logic into the versions for determining the security-related attributes of the computer on which the software is to be executed.

6. The generation processor according to claim 5 wherein the logic is incorporated in a dynamic link library.

7. The generation processor according to claim 4 wherein the generator adds logic into the versions to use the security-related attributes of the computer on which the software is to be executed.

8. The generation processor according to claim 7 wherein the logic is incorporated in a dynamic link library.

9. The generation processor according to claim 3 wherein the generator modifies the system-level behavior of the software.

10. The generation processor according to claim 9 wherein the generator modifies the file input/output resources used by the software.

11. The generation processor according to claim 9 wherein the generator modifies the user-machine interface used by the software.

12. The generation processor according to claim 9 wherein the generator modifies the operating system resources as used by the application.

13. The generation processor according to claim 12 wherein the generator creates proxies.

14. An execution processor at a second computer for receiving from a first computer, a software product for execution on the second computer in the form of a first version of the software having a limited functionality and a second version of the software having increased functionality which is dependent upon and utilizes security-related attributes of the computer on which the program is to be executed, the execution processor comprising:
an assessor for identifying, prior to execution of the first version, the security-related attributes of the second computer;
a version initiator for initiating the execution of the second version in the place of the first version if the security-related attributes of the second computer supports the increased functionality of the second version during which the security-related attributes of the second computer are utilized; and
a code processor for executing the version of the software to be executed.

15. The execution processor according to claim 14 wherein the security-related attribute of the second computer on which the second version depends comprises an attribute of the environment in which the second computer executes programs.

16. The execution processor according to claim 15 wherein the presence or absence of the attribute is used in conjunction with other attributes to compute a figure of merit which determines whether the second version can be executed.

17. The execution processor according to claim 15 wherein the attribute comprises the presence or absence of an adjunct device on the second computer.

18. The execution processor according to claim 17 wherein the adjunct device is tamper-resistant.

19. The execution processor according to claim 17 wherein the adjunct device is a dongle.

20. The execution processor according to claim 15 wherein the attribute comprises the presence of an authenticable security capability on a network coupled to the second computer.

21. The execution processor according to claim 15 wherein the attribute comprises the presence or absence of software for execution on the second computer.

22. The execution processor according to claim 22 wherein the software comprises a run-time debugger.

23. The execution processor according to claim 15 wherein the attribute comprises the presence or absence of local storage with pre-determined attributes.

24. The execution processor according to claim 15 wherein the attribute comprises the presence or absence of a network connection.

25. The execution processor according to claim 15 wherein the attribute comprises the presence or absence of a user certificate.

26. The execution processor according to claim 25 wherein the user certificate is an X.509 certificate.

27. The execution processor according to claim 15 wherein the attribute comprises the presence or absence of a currently valid logon session with an identified user.

28. The execution processor according to claim 15 wherein the attribute comprises the presence or absence of an “always-on” network connection.

29. The execution processor according to claim 15 wherein the attribute comprises evidence of registration of the upgraded program for the second computer.

30. The execution processor according to claim 15 wherein the attribute comprises the presence or absence of a cryptographic co-processor.

31. The execution processor according to claim 15 wherein the attribute comprises the presence or absence of a smart-card reader adapted to be coupled with a smart-card.

32. The execution processor according to claim 15 wherein the attribute comprises the presence or absence of a smart-card coupled to the second computer through a smart-card reader.

33. The execution processor according to claim 15 wherein the attribute comprises the presence or absence of a connection to the internet.

34. The execution processor according to claim 15 wherein the attribute comprises an independent authentication for user identification.

35. The execution processor according to claim 14, wherein the second computer initially installs only the first version from the first computer and the version initiator installs the second version of the software and executes it only if the security-related attributes of the second computer supports its increased functionality.

36. The execution processor according to claim 35 wherein the receipt of the second version requires the security-related attributes of the second computer to be utilized.

37. The execution processor according to claim 36 wherein the second version is encrypted.

38. The execution processor according to claim 36 wherein the second version is accessed at a URL which is encrypted.

39. The execution processor according to claim 14 wherein the version initiator makes use of metadata files.

40. The execution processor according to claim 39 wherein the metadata files are require the security-related attributes of the second computer to be utilized.

41. A method of selectively controlling the functionality of a software product, the method comprising the steps of:
generating, at a first computer, a first version of the software having a limited functionality and a second version of the software having increased functionality which is dependent upon and utilizes security-related attributes of the computer on which the program is to be executed;
receiving the versions of the software from the first computer, at a second computer for execution thereon;
identifying, prior to execution of the first version, the security-related attributes of the second computer;
initiating the execution of the second version in the place of the first version if the security-related attributes of the second computer supports the increased functionality of the second version during which the security-related attributes of the second computer are utilized; and
executing the version of the software to be executed.

42. A computer-readable medium for storing computer-executable instructions which, when executed by a processor in a first computer, cause the processor to:
receive an original software product and to provide a first version of the software having a limited functionality and a second version of the software having increased functionality which is dependent upon and utilizes security-related attributes of the computer on which the program is to be executed,
whereby an execution processor at the second computer may receive the versions of the software from the first computer, identify, prior to execution of the first version, the security-related attributes of the second computer, initiate the execution of the second version in the place of the first version if the security-related attributes of the second computer supports the increased functionality of the second version during which the security-related attributes of the second computer are utilized and execute the version of the software to be executed.

43. A computer-readable medium for storing computer-executable instructions which, when executed by a processor in a second computer, cause the processor to:
receive from a first computer, a software product for execution on the second computer in the form of a first version of the software having a limited functionality and a second version of the program having increased functionality which is dependent upon and utilizes security-related attributes of the computer on which the program is to be executed, identify, prior to execution of the first version, the security-related attributes of the second computer;
initiate the execution of the second version in the place of the first version if the security-related attributes of the second computer supports the increased functionality of the second version during which the security-related attributes of the second computer are utilized; and
execute the version of the software to be executed.
